(19) United States
(12) Patent Application Publication
(10) Pub. No.: US 2025/0218385 A1
(43) Pub. Date: Jul. 3, 2025

(54) LEVEL SHIFTER AND DISPLAY DEVICE INCLUDING THE SAME

(71) Applicant: LG Display Co., Ltd., Seoul (KR)

(72) Inventors: Yong Woo YUN, Paju-si (KR); Dong Kyu KIM, Paju-si (KR)

(21) Appl. No.: 18/960,989

(22) Filed: Nov. 26, 2024

(30) Foreign Application Priority Data
Dec. 28, 2023 (KR) 10-2023-0193929

(51) Int. Cl. G09G 3/3258; G09G 3/20

(52) U.S. Cl. CPC G09G 3/3258; G09G 3/2092; G09G 2300/0842; G09G 2300/0861; G09G 2310/0286; G09G 2310/0289; G09G 2310/08; G09G 2320/028

(57) ABSTRACT

A level shifter according to an embodiment and a display device including the same are disclosed. A level shifter includes a first logic circuit configured to receive a mode selection signal of a first voltage level for selectively driving first and second light-emitting elements that emit light at different viewing angles of a pixel circuit from a timing controller and transmit the mode selection signal; and a second logic circuit configured to convert the mode selection signal of the first voltage level into a mode selection signal of a second voltage level higher than the first voltage level and output the converted mode selection signal of the second voltage level to the pixel circuit.

### CROSS-REFERENCE TO RELATED APPLICATION

This application claims priority to and the benefit of Korean Patent Application No. 10-2023-0193929, filed Dec. 28, 2023, the disclosure of which is incorporated herein by reference in its entirety.

### BACKGROUND

### Technical Field

The present disclosure relates to a level shifter and a display device including the same.

### Description of the Related Art

Variable viewing angle technology is being applied to display devices. Variable viewing angle technology may present video content or visual information reproduced on a display device only to a user within a narrow viewing angle range, or to multiple users within a wide viewing angle range.

As the market for future vehicles such as electric vehicles and self-driving cars expands, demand for vehicle display devices is rapidly increasing. Research is being conducted on a method of dividing the screen of a vehicle display device and controlling one part of the screen to have a narrow viewing angle and the other part to have a wide viewing angle. This technology may drive pixels with a narrow viewing angle arranged in one area of the screen to display personal contents or information that only a specific user may view, and simultaneously drive pixels with a wide viewing angle arranged in the other area of the screen to display shared contents that multiple users may view together.

In vehicle display devices, display panels for organic light emitting display devices are attracting attention. An organic light emitting display device includes an organic light emitting diode (hereinafter, referred to as “OLED”) that emits light by itself, and has an advantage in that the response speed is fast, the luminous efficiency and luminance are good, and the viewing angle is wide. The organic light emitting display device has a fast response speed, is excellent in terms of luminous efficiency, luminance and viewing angle, and provides an excellent contrast ratio and color reproducibility since it may express the black grayscale in complete black. Because the display panel of an organic light emitting display device may be flexibly bent, it may easily implement a curved surface. Due to these advantages, the share of organic light emitting display devices in the vehicle display device market is rapidly increasing.

### BRIEF SUMMARY

In a display device to which variable viewing angle technology is applied, the entire screen may be controlled to a specific viewing angle, or the viewing angle may be controlled for each screen area having a preset size. Various methods to apply a mode selection signal for such viewing angle control are required.

The present disclosure is directed to solving all the above-described necessity and problems.

The present disclosure provides a level shifter and a display device including the same.

It should be noted that objects of the present disclosure are not limited to the above-described objects, and other objects of the present disclosure will be apparent to those skilled in the art from the following descriptions.

A level shifter according to embodiments of the present disclosure may include a first logic circuit configured to receive a mode selection signal of a first voltage level for selectively driving first and second light-emitting elements that emit light at different viewing angles of a pixel circuit from a timing controller and transmit the mode selection signal of the first voltage level; and a second logic circuit configured to convert the mode selection signal of the first voltage level into a converted mode selection signal of a second voltage level higher than the first voltage level and output the converted mode selection signal of the second voltage level to the pixel circuit.

A display device according to embodiments of the present disclosure may include a display panel in which a plurality of data lines, a plurality of gate lines intersecting the data lines, and a plurality of pixel circuits each including first and second light-emitting elements that emit light at different viewing angles are disposed; a data driver configured to supply a data voltage of pixel data to the data lines; a level shifter configured to output a gate timing control signal and a mode selection signal; and a gate driver configured to generate a gate signal based on the gate timing control signal and supply the gate signal to the gate lines, wherein the level shifter includes a first logic circuit configured to receive a mode selection signal of a first voltage level for selectively driving the first and second light-emitting elements of the pixel circuits from a timing controller and transmit the mode selection signal; and a second logic circuit configured to convert the mode selection signal of the first voltage level into a mode selection signal of a second voltage level higher than the first voltage level and output the converted mode selection signal of the second voltage level to the pixel.

According to the present disclosure, a mode selection signal may be applied in a simple structure by outputting the mode selection signal for selectively driving two light-emitting elements using a level shifter and applying the outputted mode selection signal to a pixel circuit through mode lines.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIG. 2 is a circuit diagram illustrating a pixel circuit according to an embodiment of the present disclosure;

FIG. 3 is a diagram illustrating lenses disposed on first and second light-emitting elements shown in FIG. 2;

FIG. 4 is a diagram illustrating a driving waveform for each mode of the pixel circuit shown in FIG. 2;

FIGS. 5A to 5C are diagrams illustrating an operation principle of a pixel circuit based on the driving waveforms of FIG. 4;

FIG. 6 is a diagram illustrating a switching process between a first mode and a second mode;

FIG. 7 is a diagram illustrating a transmission path of a mode selection signal according to a first embodiment;

FIG. 8 is a diagram illustrating a transmission path of a mode selection signal according to a second embodiment;

FIGS. 9A to 9C are diagrams illustrating an operation principle of a level shifter according to an embodiment; and

FIGS. 10 to 12 are diagrams illustrating an arrangement position of a level shifter according to an embodiment.

### DETAILED DESCRIPTION

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS), since carriers are holes, a source voltage is higher than a drain voltage such that holes may flow from a source to a drain. In the p-channel transistor, since holes flow from the source to the drain, a current flows from the source to the drain. It should be noted that a source and a drain of a transistor are not fixed. For example, a source and a drain may be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

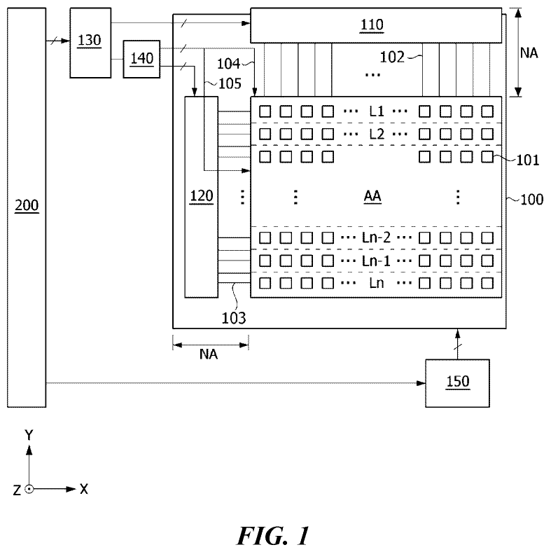

FIG. 1 is a block diagram illustrating a display device according to one embodiment of the present disclosure.

Referring to FIG. 1, the display device according to an embodiment of the present disclosure includes a display panel 100, a display panel driving circuit for writing pixel data to pixels of the display panel 100, and a power supply 140 for generating power necessary for driving the pixels and the display panel driving circuit.

The display panel 100 includes a pixel array AA that displays an input image. The pixel array AA includes a plurality of data lines 102, a plurality of gate lines 103 intersected with the data lines 102, and pixels arranged in a matrix form.

The pixel array AA includes a plurality of pixel lines L1 to Ln. Each of the pixel lines L1 to Ln includes one line of pixels arranged along a line direction X in the pixel array AA of the display panel 100. Pixels arranged in one pixel line share the gate lines 103. Sub-pixels arranged in a column direction Y along a data line direction share the same data line 102. One horizontal period 1H is a time obtained by dividing one frame period by the total number of pixel lines L1 to Ln.

Touch sensors may be disposed on the display panel 100. A touch input may be sensed using separate touch sensors or may be sensed through pixels. The touch sensors may be disposed as an on-cell type or an add-on type on the screen of the display panel or implemented as in-cell type touch sensors embedded in the pixel array AA.

The display panel 100 may be implemented as a flexible display panel. The flexible display panel may be made of a plastic OLED panel. An organic thin film may be disposed on a back plate of the plastic OLED panel, and the pixel array AA may be formed on the organic thin film.

The back plate of the plastic OLED may be a polyethylene terephthalate (PET) substrate. The organic thin film is formed on the back plate. The pixel array AA and a touch sensor array may be formed on the organic thin film. The back plate blocks moisture permeation so that the pixel array AA is not exposed to humidity. The organic thin film may be a thin Polyimide (PI) film substrate. A multi-layered buffer film may be formed of an insulating material (not shown) on the organic thin film. Lines may be formed on the organic thin film so as to supply power or signals applied to the pixel array AA and the touch sensor array.

To implement color, each of the pixels may be divided into a red sub-pixel (hereinafter referred to as “R sub-pixel”), a green sub-pixel (hereinafter referred to as “G sub-pixel”), and a blue sub-pixel (hereinafter referred to as “B sub-pixel”). Each of the pixels may further include a white sub-pixel. Each of the sub-pixels 101 includes a pixel circuit. The pixel circuit is connected to the data line 102 and the gate line 103.

The power supply 140 generates DC power required for driving the pixel array AA and the display panel driving circuit of the display panel 100 by using a DC-DC converter. The DC-DC converter may include a charge pump, a regulator, a buck converter, a boost converter, and the like. The power supply 140 may adjust a DC input voltage from a host system (not shown) and thereby generate constant voltages such as a gamma reference voltage VGMA, gate-on voltages VGH and VEH, gate-off voltages VGL and VEL, a pixel driving voltage EVDD, a pixel low-potential power supply voltage EVSS, an initialization voltage VINIT, and a reference voltage VREF. The gamma reference voltage VGMA is supplied to a data driver 110. The gate-on voltages VGH and VEH and the gate-off voltages VGL and VEL are supplied to a gate driver 120. The constant voltages such as the pixel driving voltage EVDD, the pixel low-potential power supply voltage EVSS, the initialization voltage VINIT, and the reference voltage VREF may be supplied to the pixels 101 through the power lines commonly connected to the pixels 101.

The display panel driving circuit writes pixel data of an input image to the pixels of the display panel 100 under the control of a timing controller (TCON) 130.

The display panel driving circuit includes the data driver 110 and the gate driver 120.

A de-multiplexer (DEMUX) 112 may be disposed between the data driver 110 and the data lines 102. The de-multiplexer 112 sequentially connects one channel of the data driver 110 to the plurality of data lines 102 and distributes in a time division manner the data voltage outputted from one channel of the data driver 110 to the data lines 102, thereby reducing the number of channels of the data driver 110. The de-multiplexer array 112 may be omitted. In this case, output buffers AMP of the data driver 110 are directly connected to the data lines 102.

The display panel driving circuit may further include a touch sensor driver for driving the touch sensors. The touch sensor driver is omitted from FIG. 1. In a mobile device, the timing controller 130, the power supply 140, the data driver 110, and the like may be integrated into one drive integrated circuit (IC).

The data driver 110 generates a data voltage Vdata by converting pixel data of an input image received from the timing controller 130 with a gamma compensation voltage every frame period by using a digital to analog converter (DAC). The gamma reference voltage VGMA is divided for respective gray scales through a voltage divider circuit. The gamma compensation voltage divided from the gamma reference voltage VGMA is provided to the DAC of the data driver 110. The data voltage Vdata is outputted through the output buffer AMP in each of the channels of the data driver 110.

In the data driver 110, the output buffer included in one channel may be connected to adjacent data lines 102 through the de-multiplexer array 112 (not shown). The de-multiplexer array 112 may be formed directly on the substrate of the display panel 100 or integrated into one drive IC together with the data driver 110.

The gate driver 120 may be implemented as a gate in panel (GIP) circuit formed directly on a bezel BZ area of the display panel 100 together with the TFT array of the pixel array AA. The gate driver 120 sequentially outputs gate signals to the gate lines 103 under the control of the timing controller 130. The gate driver 120 may sequentially supply the gate signals to the gate lines 103 by shifting the gate signals using a shift register.

The timing controller 130 receives digital video data DATA of an input image and timing signals synchronized with the digital video data from the host system. The timing signals may include a vertical synchronization signal Vsync, a horizontal synchronization signal Hsync, a clock CLK, a data enable signal DE, and the like. The vertical synchronization signal Vsync and the horizontal synchronization signal Hsync may be omitted since a vertical period and a horizontal period may be obtained by a method of counting the data enable signal DE. The data enable signal DE has a period of one horizontal period 1H.

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. A mode selection signal output from the timing controller 130 may be input to mode selection circuit through the level shifter 140. Here, the mode selection signal may include a first mode selection signal S_sel for a first mode and a second mode selection signal P_sel for a second mode.

The level shifter 140 may convert and output a voltage of signal received from the timing controller 130 to a swing width between the gate high voltage and the gate low voltage. The level shifter 140 may decode the gate timing signal to output a start pulse and a clock for driving the gate driver 120, and may decode the mode selection signal to output a mode selection signal. Each of the start pulse, clock, and mode selection signals may be an alternating current signal that swings between a gate high voltage and a gate low voltage.

The host system 200 may include a main board of one of a television system, a set-top box, a navigation system, a personal computer (PC), a home theater system, a vehicle system, and a mobile device system. In this case, the data driver 110, the gate driver 120, the timing controller 130, and the like may be integrated into one drive IC (DIC) in mobile devices or wearable devices.

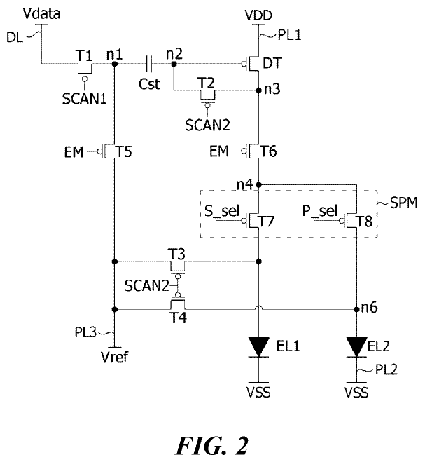

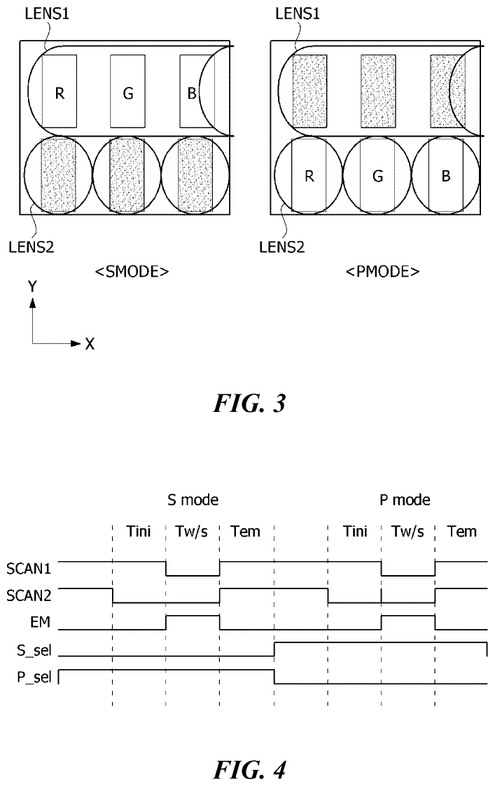

FIG. 2 is a circuit diagram illustrating a pixel circuit according to an embodiment of the present disclosure. FIG. 3 is a diagram illustrating lenses disposed on first and second light-emitting elements shown in FIG. 2.

Referring to FIGS. 2 and 3, the pixel circuit includes a first light-emitting element EL1 configured to emit light in a first mode SMODE, a second light-emitting element EL2 configured to emit light in a second mode PMODE, the driving element DT configured to drive the first and second light-emitting elements EL1 and EL2, a plurality of switch elements T1 to T6, a first mode switch element M1, a second mode switch element M2, and a capacitor Cst. The driving element DT, the switch elements T1 to T6 and the first and second switch elements M1 and M2 may be implemented as p-channel transistors, but the present disclosure is not limited thereto.

The pixel circuit is connected to power lines, to which DC voltages (or constant voltages) are applied, such as a pixel driving voltage line or a first power line PL1 to which a pixel driving voltage VDD is applied, a pixel base voltage line or a second power line PL2 to which a pixel base voltage VSS is applied, and a reference voltage line or a third power line PL3 to which a reference voltage Vref is applied. Power lines may be commonly connected to all the pixels on the display panel 100.

The pixel driving voltage VDD is set to a voltage higher than the maximum voltage of the data voltage Vdata and allows the driving element DT to operate in a saturation region. The pixel driving voltage VDD is a voltage higher than the pixel base voltage VSS. The reference voltage Vref may be set to a voltage that is lower than the pixel driving voltage VDD and higher than the pixel base voltage VSS. A gate-on voltage VGL may be set to a voltage higher than the pixel driving voltage VDD and a gate-off voltage VGH may be set to a voltage lower than the pixel base voltage VSS.

The driving element DT drives the first and second light-emitting elements EL1 and EL2 by generating a current according to a gate-source voltage Vgs. The driving element DT includes a first electrode connected to the first power line PL1 to which the pixel driving voltage VDD is applied, a gate electrode connected to a second node n2, and a second electrode connected to a third node n3.

The first and second light-emitting elements EL1 and EL2 may be implemented as organic light-emitting diodes (OLEDs). Each of the light-emitting elements EL1 and EL2 includes an anode, a cathode, and an organic compound layer formed between the anode and the cathode. The anode of the first light-emitting element EL1 is connected to a fifth node n5, and the cathode thereof is connected to the second power line PL2 to which the pixel base voltage VSS is applied. The anode of the second light-emitting element EL2 is connected to a sixth node n6, and the cathode thereof is connected to the second power line PL2. The organic compound layer may include a hole injection layer HIL, a hole transport layer HTL, an emission layer EML, an electron transport layer ETL, and an electron injection layer EIL, but the present disclosure is not limited thereto. Each of the light-emitting elements EL1 and EL2 may be implemented in a tandem structure in which a plurality of light-emitting layers are stacked. The light-emitting elements EL1 and EL2 of the tandem structure may improve the luminance and lifetime of the pixel.

A first switch element T1 is connected between the data line DL and the first node n1. The first switch element T1 is turned on according to a gate-on voltage VGL of a first gate signal SCAN1 to apply the data voltage Vdata of pixel data to the first node n1. The first switch element T1 includes a first electrode connected to the data line DL, a gate electrode to which the first gate signal SCAN1 is applied, and a second electrode connected to the first node n1.

A second switch element T2 is connected between the second node n2 and the third node n3. The second switch element T2 is turned on according to a gate-on voltage VGL of a second gate signal SCAN2 to connect the gate electrode and second electrode of the driving element DT. The second switch element T2 includes a first electrode connected to the second node n2, a gate electrode to which the second gate signal SCAN2 is applied, and a second electrode connected to the third node n3.

A third switch element T3 is connected between the first node n1 and the third power line PL3. The third switch element T3 is turned on according to the gate-on voltage VGL of the third gate signal EM to connect the first node n1 to the third power line PL3. The third switch element T3 includes a first electrode connected to the first node n1, a gate electrode to which the third gate signal EM is applied, and a second electrode connected to the third power line PL3.

A fourth switch element T4 is connected between the third node n3 and the fourth node n4. The fourth switch element T4 is turned on according to a gate-on voltage VGL of a third gate signal EM to connect the third node n3 to the fourth node n4. The fourth switch element T4 includes a first electrode connected to the third node n3, a gate electrode to which the third gate signal EM is applied, and a second electrode connected to the fourth node n4.

A fifth switch element T5 is connected between the fifth node n5 and the third power line PL3. The fifth switch element T5 is turned on according to the gate-on voltage VGL of the second gate signal SCAN2 to connect the fifth node n5 to the third power line PL3. The fifth switch element T5 includes a first electrode connected to the third power line PL3, a gate electrode to which the second gate signal SCAN2 is applied, and a second electrode connected to the fifth node n5.

A sixth switch element T6 is connected between the sixth node n6 and the third power line PL3. The sixth switch element T6 is turned on according to a gate-on voltage VGL of the second gate signal SCAN2 to connect the sixth node n6 to the third power line PL3 to which the reference voltage Vref is applied. The sixth switch element T6 includes a first electrode connected to the third power line PL3, a gate electrode to which the second gate signal SCAN2 is applied, and a second electrode connected to the sixth node n6.

A first mode switch element M1 is connected between the fourth node n4 and the fifth node n5. The first mode switch element M1 is turned on according to a gate-on voltage VGL of a first mode selection signal S_sel to connect the fourth node n4 to the fifth node n5. The first mode switch element M1 includes a first electrode connected to the fourth node n4, a gate electrode to which the first mode selection signal S_sel is applied, and a second electrode connected to the fifth node n5.

A second mode switch element M2 is connected between the fourth node n4 and the sixth node n6. The second mode switch element M2 is turned on according to a gate-on voltage VGL of a second mode selection signal P_sel to connect the fourth node n4 to the sixth node n6. The second mode switch element M2 includes a first electrode connected to the fourth node n4, a gate electrode to which the second mode selection signal P_Sel is applied, and a second electrode connected to the sixth node n6.

The capacitor Cst is connected between a first node n1 and the second node n2. The capacitor Cst maintains the gate-source voltage Vgs of the driving element DT during a light-emitting period.

Referring to FIG. 3, a first lens LENS1 shown in FIG. 3 may be disposed on the first light-emitting element EL1. The first lens LENS1 may be a semi-cylindrical lens in order to limit a vertical viewing angle and widen a horizontal viewing angle. The first lens LENS1 is long in a horizontal direction (or the X-axis direction) of the display panel 100 and narrow in a vertical direction thereof. The first lens LENS1 may have a hemispherical cross section. The first lens condenses light traveling in the vertical direction among light of the first light-emitting element EL1 emitted in the first mode to narrow the vertical viewing angle and widen the horizontal viewing angle. By the first lens LENS1, the vertical viewing angle of the first light-emitting element EL1 is comparable to that of the second light-emitting element EL2, and the horizontal viewing angle thereof is larger than that of the second light-emitting element EL2. In FIG. 3, “R” indicates a red sub-pixel that emits light, “G” indicates a green sub-pixel that emits light, and “B” indicates a blue sub-pixel that emits light. The sub-pixels darkly expressed in FIG. 3 are non-driving sub-pixels that do not emit light.

Light emitted from a screen of a vehicle display disposed on a dashboard of a vehicle may travel to a front-facing camera disposed in front of an upper end of a room in the vehicle, and the screen of the vehicle display may be seen in an image captured by the front-facing camera. The first lens LENS1 limits the vertical viewing angle of the first light-emitting element EL1 that emits light in the first mode to prevent a ghost image of the screen of the vehicle display, which is captured by the front-facing camera.

A second lens LENS2 shown in FIG. 3 may be disposed on the second light-emitting element EL2. The second lens LENS2 may be a semi-spherical lens whose thickness is larger at the center and smaller toward an edge thereof. The second lens LENS2 may condense light of the second light-emitting element EL2 emitted in the second mode to narrow up-down and left-right viewing angles of the second light-emitting element EL2.

The first and second lenses LENS1 and Lens2 may be implemented as transparent media or transparent insulating layer patterns disposed in the display panel 100, but the present disclosure is not limited thereto.

The first light-emitting element EL1 emits light at a first viewing angle by the first lens LENS1, and the second light-emitting element EL2 emits light at a second viewing angle smaller than the first viewing angle by the second lens LENS2.

This pixel circuit may be driven in a first mode in which the first light-emitting device EL1 with a narrow viewing angle emits light, or in a second mode in which the second light-emitting device EL2 in a wide viewing angle emits light.

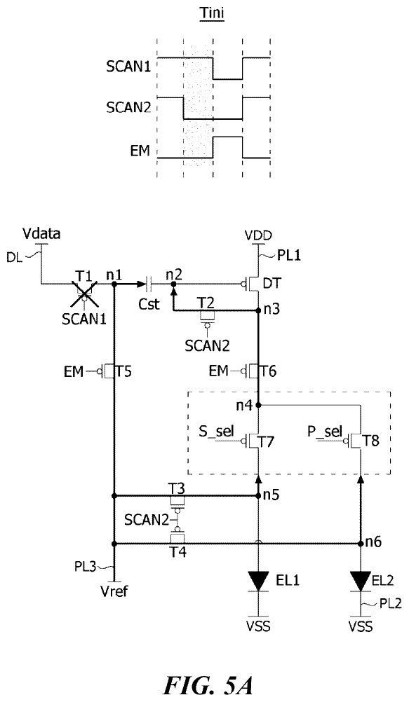

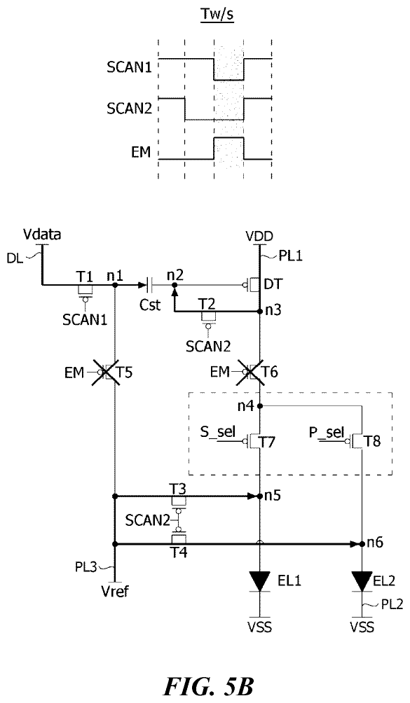

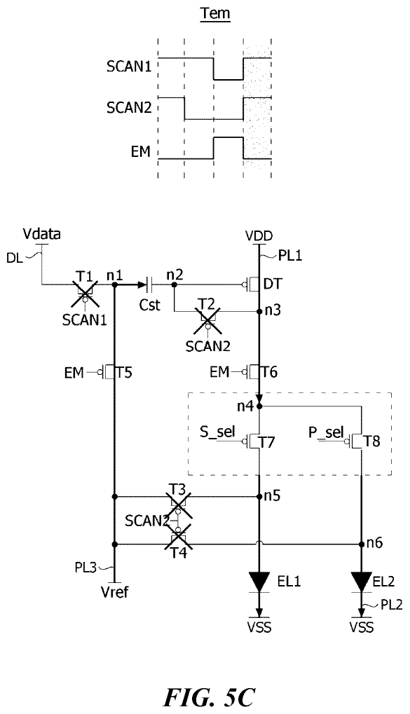

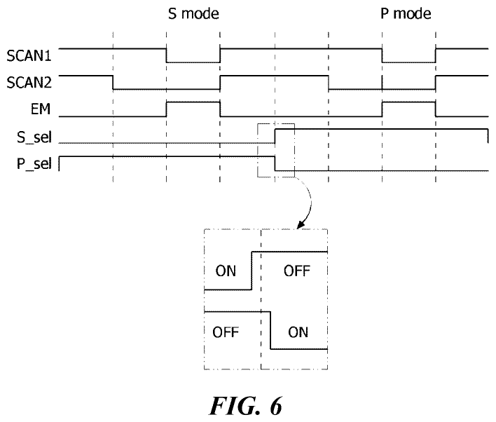

FIG. 4 is a diagram illustrating a driving waveform for each mode of the pixel circuit shown in FIG. 2. FIGS. 5A to 5C are diagrams illustrating an operation principle of a pixel circuit based on the driving waveforms of FIG. 4. FIG. 6 is a diagram illustrating a switching process between a first mode and a second mode.

Referring to FIG. 4, the pixel circuit is driven in the order of an initialization period Tini, a data writing and sensing period Tw/s, and an emission period Tem in the first mode and the second mode. The time during which the initialization period Tini, the data writing and sensing period Tw/s, and the emission period Tem are performed may be controlled by the waveforms of the gate signals SCAN1, SCAN2, and EM.

Referring to FIG. 5A, during the initialization period Tini, the first switch element T1 is turned off, and the second to sixth switch elements T2 to T6 are turned on, so that the reference voltage Vref may be applied to the first node n1.

In this case, when the first mode switch element M1 is turned on in the first mode, the reference voltage Vref is applied to the second node n2 through the first mode switch element M1, and when the second mode switch element M2 is turned on in the second mode, the reference voltage Vref is applied to the second node n2 through the second mode switch element M2.

Referring to FIG. 5B, during the data writing and sensing period Tw/s, the third and fourth switch elements T3 and T4 and the first and second switch elements T1 and T2 are turned on, and the fifth and sixth switch elements T5 and T6 are turned off, so that the data voltage Vdata of the pixel data is applied to the first node n1 and the pixel driving voltage VDD is applied to the driving element to sense the threshold voltage Vth of the driving element, resulting in the voltage at the second node n2 being VDD+Vth.

Referring to FIG. 5C, during the emission period Tem, the first and second switch elements T1 and T2 and the third and fourth switch elements T3 and T4 are turned off, and the fifth and sixth switch elements T5 and T6 are turned on, so that a current generated based on the gate-source voltage of the driving element DT is supplied to the first light-emitting element EL1 or the second light-emitting element EL2, causing them to emit light.

In this case, when the first mode switch element M1 is turned on in the first mode, the current generated based on the gate-source voltage of the driving element DT is supplied to the first light-emitting element EL1 through the first mode switch element M1, and when the second mode switch element M2 is turned on in the second mode, the current generated based on the gate-source voltage of the driving element DT is supplied to the second light-emitting element EL2 through the second mode switch element M2.

In the pixel circuit according to an embodiment, the mode selection signals may be applied in a non-overlapping manner such that both the first light-emitting element and the second light-emitting element go through a turn-off state for a very short time when switching from the first mode to the second mode or from the second mode to the first mode, as shown in FIG. 6.

For example, it may be designed to have a predetermined time interval between the rising time point of the first mode selection signal S_sel and the falling time point of the second mode selection signal P_sel.

Since the first mode selection signal S_sel and the second mode selection signal P_sel are generated by the timing controller but are not gate signals, they are applied to the pixel circuit through a level shifter.

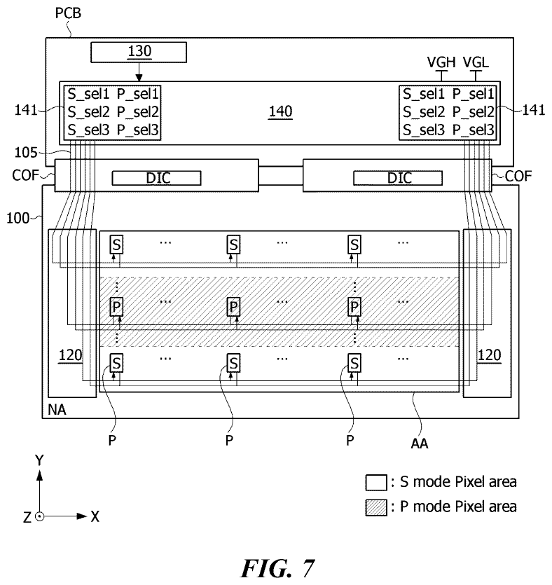

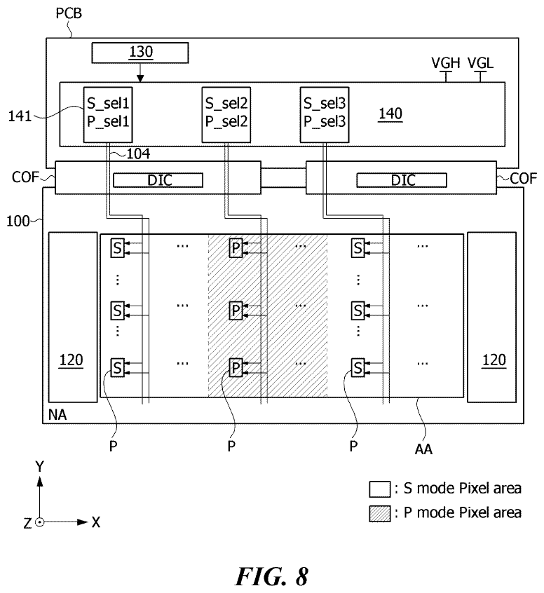

FIG. 7 is a diagram illustrating a transmission path of a mode selection signal according to a first embodiment. FIG. 8 is a diagram illustrating a transmission path of a mode selection signal according to a second embodiment.

Referring to FIG. 7, the display panel 100 according to a first embodiment may further include a plurality of horizontal mode lines 105 for transmitting the mode selection signals S_sel and P_sel. The horizontal mode lines 105 are arranged parallel to the gate lines and connected to the pixel circuit of each pixel.

The horizontal mode lines 105 may be arranged side by side in the non-display area on the left and right sides of the display panel, and may be arranged parallel to the gate lines in the display area.

In this case, since the horizontal mode lines 105 are disposed to bypass the non-display area where the circuits of the gate driver are disposed, some of the horizontal mode lines 105 may overlap the circuits of the gate driver with an insulating layer therebetween.

Referring to FIG. 8, the display panel 100 according to a second embodiment may further include a plurality of vertical mode lines 104 for transmitting the mode selection signals S_sel and P_sel. The vertical mode lines 104 are arranged parallel to the data lines and connected to the pixel circuit of each pixel.

The display device may include a circuit board PCB and a chip on film (COF) electrically connected to the display panel 100. A source driver IC (DIC) in which the circuit of the data driver 110 is integrated may be mounted on a flexible film of the COF. The circuit board PCB includes a timing controller 130, a level shifter 140, a power supply 150, and the like. The circuit board PCB may be electrically connected to the COF.

The COF may be disposed between the circuit board PCB and the display panel 100 to electrically connect the circuit board PCB to the display panel 100, and may supply the data voltage outputted from the source driver IC (DIC) to the data lines on the display panel 100.

A gate timing control signal and a mode selection signal outputted from the timing controller 130 may be provided to the level shifter 140. The level shifter 140 receives a signal from the timing controller 130, a gate high voltage VGH, and a gate low voltage VGL. The level shifter 140 decodes the gate timing control signal to output a start pulse and a clock swinging between the gate high voltage VGH and the gate low voltage VGL. The start pulse and the clock are supplied to the gate driver 120. The gate driver 120 may output a pulse of the gate signal when the start pulse and the clock are inputted.

The level shifter 140 decodes the mode selection signal to output the mode selection signals S_sel and P_sel swinging between the gate high voltage VGH and the gate low voltage VGL.

The mode selection signals S_sel and P_sel may be supplied to a pixel circuit P of the pixels through the corresponding vertical mode lines 104 and horizontal mode lines 105. Each of the pixels may be individually driven in a viewing angle mode indicated by the mode selection signals S_sel and P_sel.

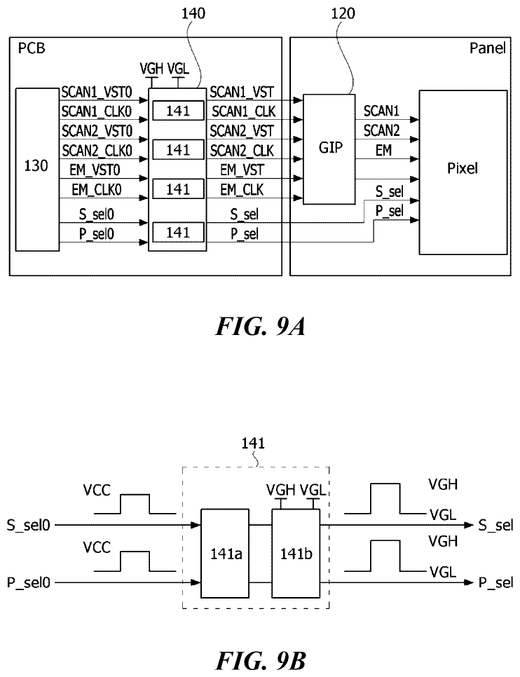

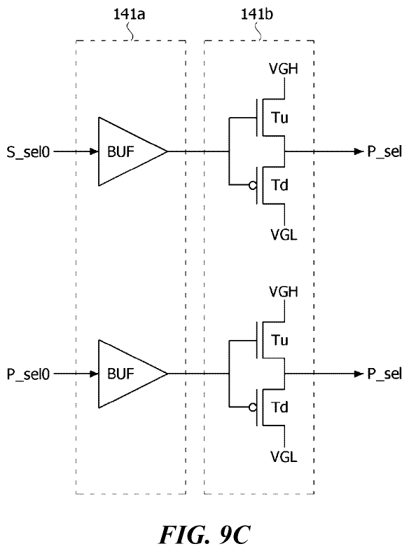

FIGS. 9A to 9C are diagrams illustrating an operation principle of a level shifter according to an embodiment.

Referring to FIG. 9A, the level shifter 140 may receive the mode selection signal as well as a start signal VST0 and a clock signal CLK0 of a first voltage level from the timing controller 130. For example, the start signal and the clock signal may include start signals SCAN1_VST0 and SCAN2_VST0 and clock signals SCAN1_CLK0 and SCAN2_CLK0 for the scan driver, and a start signal EM_VST0 and a clock signal EM_CLK0 for the EM driver. The mode selection signal may include a first mode selection signal S_sel0 and a second mode selection signal P_sel0.

The level shifter 140 may include a logic circuit 141 for converting a voltage level. The logic circuit may be implemented as a plurality of logic circuits that convert the voltage level of each of the signals SCAN1_VST0, SCAN1_CLK0, SCAN2_VST0, SCAN2_CLK0, EM_VST0, EM_CLK0, S_sel0, and P_sel0.

In one example, the logic circuit 141 may convert the start signals SCAN1_VST0, SCAN2_VST0, and EM_VST0 and the clock signals SCAN1_CLK0, SCAN2_CLK0, and EM_CLK0 of the first voltage level into a start signal VST and a clock signal CLK of a second voltage level, and apply them to the gate driver. The gate driver may generate gate signals SCAN1, SCAN2, and EM based on the start signal VST and the clock signal CLK and apply them to the pixel circuit through the gate line.

In another example, the logic circuit 141 may receive the first and second mode selection signals S_sel0 and P_sel0 of a first voltage level VCC and output the first and second mode selection signals S_sel and P_sel of a second voltage level.

The first and second mode selection signals S_sel and P_sel outputted from the logic circuit 141 may be applied to the pixel circuit through the vertical mode lines 104 or the horizontal mode lines 105.

Referring to FIGS. 9B and 9C, the logic circuit 141 according to an embodiment may include a first logic circuit 141a and a second logic circuit 141b. The first logic circuit 141a may receive the first and second mode selection signals S_sel0 and P_sel0 of the first voltage level from the timing controller and transmit them to the second logic circuit 141b. For example, the first logic circuit 141a may be implemented as a buffer BUF, but the present disclosure is not limited thereto.

The second logic circuit 141b may convert the first and second mode selection signals S_sel0 and P_sel0 of the first voltage level into the first and second mode selection signals S_sel and P_sel of the second voltage level swinging between the gate high voltage VGH and the gate low voltage VGL, and output them. For example, the second logic circuit 141b may be implemented as a pull-up transistor Tu and a pull-down transistor Td, but the present disclosure is not limited thereto. The pull-up transistor Tu may convert high voltage level of the first and second mode selection signals S_sel0 and P_sel0 into the the gate high voltage VGH of the first and second mode selection signals S_sel and P_sel and the pull-down transistor Td may convert low voltage level of the first and second mode selection signals S_sel0 and P_sel0 into the gate low voltage VGL of the first and second mode selection signals S_sel and P_sel.

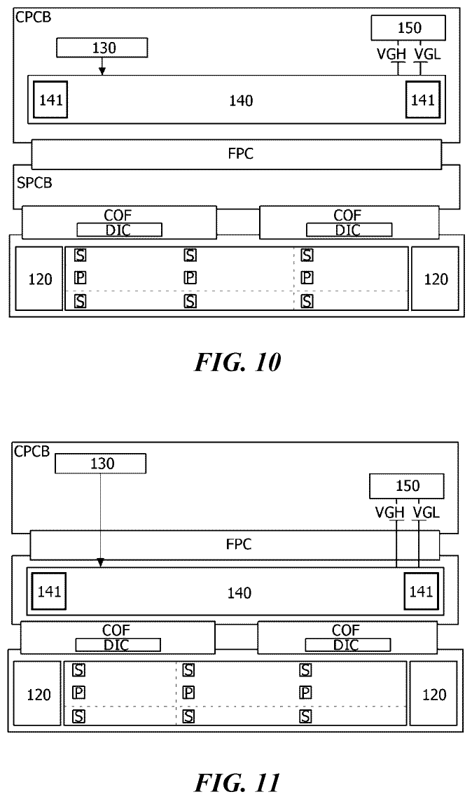

FIGS. 10 to 12 are diagrams illustrating an arrangement position of a level shifter according to an embodiment.

Referring to FIGS. 10 to 12, the level shifter according to an embodiment may be disposed in a control PCB (CPCB), a source PCB (SPCB), or a DIC. The level shifter is preferably disposed in the CPCB since it has the same number of input and output signals and changes only the voltage level of the signals.

As shown in FIG. 10, the level shifter may be disposed in the CPCB. The logic circuit of the level shifter may convert the voltage level of the mode selection signal and output it. The mode selection signal outputted from the logic circuit passes through a flexible printed circuit (FPC), the SPCB, and a chip on film (COF), and is then supplied to the pixel circuit through the non-display area in the display panel.

Accordingly, the mode lines including the horizontal and vertical mode lines are connected to the level shifter 140 disposed in the CPCB, pass through the FPC, the SPCB, and the COF, and are also connected to the pixel circuit through the non-display area in the display panel.

As shown in FIG. 11, the level shifter may be disposed in the SPCB. The mode selection signal outputted from the logic circuit passes through the COF and is then supplied to the pixel circuit through the non-display area in the display panel.

Accordingly, the mode lines including the horizontal and vertical mode lines are connected to the level shifter 140 disposed in the SPCB, pass through the COF, and are also connected to the pixel circuit through the non-display area in the display panel.

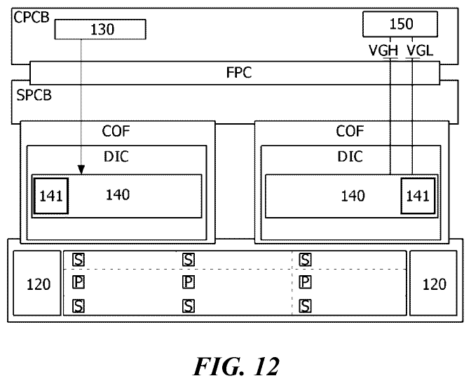

As shown in FIG. 12, the level shifter may be disposed in the DIC. The mode selection signal outputted from the logic circuit passes through the COF and is then supplied to the pixel circuit through the non-display area in the display panel.

Accordingly, the mode lines including the horizontal and vertical mode lines are connected to the level shifter 140 disposed in the DIC and are also connected to the pixel circuit through the non-display area in the display panel.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A level shifter comprising:
a first logic circuit configured to receive a mode selection signal of a first voltage level for selectively driving first and second light-emitting elements that emit light at different viewing angles of a pixel circuit from a timing controller and transmit the mode selection signal of the first voltage level; and
a second logic circuit configured to convert the mode selection signal of the first voltage level into a converted mode selection signal of a second voltage level higher than the first voltage level and output the converted mode selection signal of the second voltage level to the pixel circuit.

2. The level shifter of claim 1, wherein the second voltage level of the converted mode selection signal swings between a gate high voltage and a gate low voltage.

3. The level shifter of claim 2, wherein the second logic circuit receives the gate high voltage and the gate low voltage from a power supply.

4. A display device comprising:
a display panel in which a plurality of data lines, a plurality of gate lines intersecting the data lines, and a plurality of pixel circuits each including first and second light-emitting elements that emit light at different viewing angles are disposed;
a data driver configured to supply a data voltage of pixel data to the data lines;
a level shifter configured to output a gate timing control signal and a mode selection signal; and
a gate driver configured to generate a gate signal based on the gate timing control signal and supply the gate signal to the gate lines,
wherein the level shifter includes:
a first logic circuit configured to receive a mode selection signal of a first voltage level for selectively driving the first and second light-emitting elements of the pixel circuits from a timing controller and transmit the mode selection signal; and
a second logic circuit configured to convert the mode selection signal of the first voltage level into a converted mode selection signal of a second voltage level higher than the first voltage level and output the converted mode selection signal of the second voltage level to the pixel circuits.

5. The display device of claim 4, wherein the level shifter and the pixel circuits are electrically connected through mode lines, and
wherein the mode selection signal of the second voltage level outputted from the level shifter is applied to the pixel circuits through the mode lines.

6. The display device of claim 5, wherein the level shifter is disposed in a control printed circuit board (CPCB), and
the mode lines pass through a flexible printed circuit (FPC), a source printed circuit board (SPCB), and a chip on film (COF) and then are connected to the pixel circuits through a non-display area of the display panel.

7. The display device of claim 6, wherein the mode lines are arranged side by side in the non-display area of the display panel and are arranged in parallel with the gate lines in a display area of the display panel.

8. The display device of claim 6, wherein the mode lines are arranged side by side in the non-display area of the display panel and are arranged in parallel with the data lines in a display area of the display panel.

9. The display device of claim 4, wherein the second voltage level of the converted mode selection signal swings between a gate high voltage and a gate low voltage.

10. The display device of claim 9, wherein the second logic circuit receives the gate high voltage and the gate low voltage from a power supply.

11. The display device of claim 4. wherein the level shifter is disposed in any one of a control printed circuit board (CPCB), a source printed circuit board (SPCB), and a driver integrated circuit (DIC).
